(19) United States
(12) Patent Application Publication
(10) Pub. No.: US 2017/0349821 A1
(43) Pub. Date: Dec. 7, 2017

(54) MICROENCAPSULATION OF TREATMENT CHEMICALS FOR USE IN SUBTERRANEAN FORMATIONS

(71) Applicant: Multi-Chem Group, LLC, San Angelo, TX (US)

(72) Inventors: Fang Wei, Houston, TX (US); Pushkala Krishnamurthy, Pearland, TX (US); Ying Cong Jiang, Pearland, TX (US); Erick J. Acosta, Sugar Land, TX (US)

(73) Assignee: Multi-Chem Group, LLC, San Angelo, TX (US)

(21) Appl. No.: 15/522,553

(22) PCT Filed: Dec. 3, 2014
(86) PCT No.: PCT/US2014/068354

§ 371 Date: Apr. 27, 2017

(51) Int. Cl. C09K 8/92; E21B 43/26; E21B 41/02; C09K 8/524; C09K 8/536; C09K 8/70; C09K 8/60; C09K 8/54; E21B 43/267; E21B 37/06

(52) U.S. Cl. CPC C09K 8/92; E21B 43/267; E21B 43/26; E21B 41/02; E21B 37/06; C09K 8/536; C09K 8/70; C09K 8/602; C09K 8/54; C09K 8/524; C09K 2208/20

(57) ABSTRACT

Certain particulates of encapsulated treatment chemicals, and methods of and systems for their use in subterranean formations, are provided. In one embodiment, the methods comprise: providing a plurality of treatment particulates, at least one of which comprising a polymer matrix that comprises and/or encages at least one treatment chemical and a coating disposed around an outer surface of the polymer matrix; and introducing the treatment particulates into a well bore penetrating at least a portion of a subterranean formation.

### BACKGROUND

The present disclosure relates to systems and methods for treating subterranean formations.

In hydrocarbon exploration and production, a variety of treatment chemicals may be used to facilitate the production of the hydrocarbons from subterranean formations. These include paraffin inhibitors, gel breakers, dispersing agents, and defoamers, among others. Unfortunately, many treatment chemicals may be adversely affected by exposure to the well bore environment before the chemicals reach their desired destinations in the subterranean formation. This can result in the reaction of the treatment chemical within the well bore, which, depending on the treatment chemical, could affect negatively the production potential of the well. The effectiveness of the treatment chemical may be adversely affected if released prematurely.

In some cases, treatment chemicals such as paraffin inhibitors have been absorbed into pores of silicon-based materials that may be delivered into a particular area of a subterranean formation. However, such delivery mechanisms may not provide any delay in the release of treatment chemicals into the formation, and thus such chemicals may be depleted by the time the material reaches certain portions of a well. Moreover, the capacity of such mechanisms to carry treatment chemicals may be limited by the porosity of the silicon-based materials. In some cases, excessive amounts of the solid carrier materials may be needed to deliver an appropriate amount of a treatment chemical to the formation.

### BRIEF DESCRIPTION OF THE DRAWINGS

These drawings illustrate certain aspects of some of the embodiments of the present disclosure, and should not be used to limit or define the claims.

FIG. 1 is a diagram illustrating an example of a fracturing system that may be used in accordance with certain embodiments of the present disclosure.

FIG. 2 is a diagram illustrating an example of a subterranean formation in which a fracturing operation may be performed in accordance with certain embodiments of the present disclosure.

FIG. 3 is a diagram illustrating one embodiment of a treatment particulate of the present disclosure.

FIG. 3A is a diagram illustrating another embodiment of a treatment particulate of the present disclosure.

FIG. 4 is a diagram illustrating another embodiment of a treatment particulate of the present disclosure.

FIG. 5 is a diagram illustrating another embodiment of a treatment particulate of the present disclosure.

While embodiments of this disclosure have been depicted, such embodiments do not imply a limitation on the disclosure, and no such limitation should be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DESCRIPTION OF CERTAIN EMBODIMENTS

The present disclosure relates to systems and methods for treating subterranean formations. More particularly, the present disclosure relates to particulates of encapsulated treatment chemicals, and methods of and systems for their use in subterranean formations.

The treatment particulates of the present disclosure generally comprise discrete particulates comprised of a polymer matrix that comprises and/or encages one or more treatment chemicals. The treatment particulates of the present disclosure are also coated with one or more layers of materials disposed around an outer surface of the polymer matrix that temporarily either completely or substantially encapsulate the polymer matrix. The treatment particulates of the present disclosure may be introduced into at least a portion of a subterranean formation where the treatment chemical(s) are intended to accomplish or provide one or more treatments therein. Once delivered (or as they are being delivered) to the subterranean formation, the coating on the treatment particulates of the present disclosure may begin to dissolve, degrade, or otherwise be removed from the surface of the polymer matrix. Once the coating has at least partially been removed from the particulate, the treatment chemical may interact with components in the subterranean formation, e.g., by diffusing out of the polymer matrix. The dissolution or degradation of the coating, followed by the diffusion of the treatment chemical through the polymer matrix may provide a two-step release process to provide a delayed, controlled release of treatment chemical and avoid premature release of the chemical.

Among the many potential advantages to the methods and compositions of the present disclosure, only some of which are alluded to herein, the methods, compositions, and systems of the present disclosure may, among other benefits, provide a means for selective, delayed, and/or controlled release of one or more treatment chemicals in subterranean treatment operations. As used herein, “delayed release” and variations of that phrase may refer to the ability of a treatment particulate of the present disclosure and/or the treatment chemical(s) therein (e.g., by virtue of the coating on the outer surface of a particulate) to maintain its structural integrity during deployment and/or after placement in the formation for some period of time. In some cases, the treatment particulates of the present disclosure may be able to resist shear forces in a formation, for example, during fracturing operations to delay the release of the treatment chemicals therein. As used herein, “controlled release” and variations of that phrase may refer to the ability of a treatment particulate of the present disclosure to maintain a certain rate at which the treatment chemical in the treatment particulate is released from the polymer matrix. In some embodiments, a “controlled release” may be provided, among other reasons, to maintain certain concentration levels of a treatment chemical in a fluid over a certain period of time.

In some embodiments, the treatment particulates of the present disclosure may be used to deliver larger amounts of treatment chemicals than other means known in the art like porous solid particles, for example, because the carrying capacity of treatment particulates of the present disclosure may not be limited by the porosity of such solids. In certain embodiments, the treatment particulates of the present disclosure may delay the release of a treatment chemical in a subterranean formation for up to about a month, and may target a controlled slow release of that treatment chemical over 6 months or more at temperature and pressure conditions in a subterranean formation.

The polymer matrix generally comprises a three-dimensional organic, inorganic or hybrid structure composed of repeat units of a desired chemical functional group that possesses mechanical, chemical and physical properties commiserate with the use of the encaged treatment chemical. The number of the repeat units of the material is not critical, e.g., oligomers may be suitable in some embodiments. In certain embodiments, a polymer matrix may be a three-dimensional polymeric structure that is at least partially capable of encaging a treatment chemical. In certain embodiments, the polymer matrix may penetrate the treatment chemical. The molecular chains of the polymer matrix may react with themselves so as to entrap the treatment chemical within the resultant three-dimensional polymeric matrix. In some embodiments, the polymer matrix may be a three-dimensional hydrated structure that supports a treatment chemical. In other embodiments, the encaging polymer matrix may be dehydrated so that the pockets of polymer collapse around the treatment chemical so that the treatment chemical is released more slowly and only as the polymer rehydrates and slowly swells. The treatment chemical is then likely released at a rate of diffusion generally commiserate to the rate of diffusion of the polymer around the treatment chemical.

In certain embodiments, the polymers in the polymer matrix may be substantially inert and/or inactive in the environments in which they are used. In other embodiments, the polymers in the polymer matrix may itself comprise one or more active ingredients (e.g., treatment chemicals) that react with one or more other components to which they are exposed during use. For example, the polymer matrix may comprise ethylene vinyl acetate copolymers (which may act in certain environments as wax and/or paraffin inhibitors), olefin-maleic anhydride copolymers (OMAC), acrylate polymers, phenolic polymers, or any combinations or copolymers thereof.

The term “treatment chemical” does not imply any particular action by the chemical or a component thereof. A “treatment chemical” may be any component that is to be placed downhole to perform a desired function, e.g., act upon a portion of the subterranean formation, a tool, or a composition located downhole. Any treatment chemical that is useful down hole and that does not adversely react with the polymer carrier may be used as a treatment chemical in the present disclosure. The treatment chemical may be in solid, liquid, and/or gaseous form.

The term “encaged treatment chemical” refers to a “treatment chemical” that is encaged within a three-dimensional polymer matrix so that its release may be controlled and/or delayed. The term “encaged” does not imply a particular degree of enclosure of the treatment chemical within the polymer matrix. Both the degree of encagement and the concentration of the treatment chemical in the polymer matrix affect the rate at which the treatment chemical will ultimately be released. Thus, to provide an optimal release, the degree of encagement and the concentration of the treatment chemical in the polymer matrix should be considered. In some embodiments, the treatment chemical may be soluble in the polymeric matrix (e.g., homogeneous); in other embodiments, the treatment chemical may be insoluble (e.g., heterogeneous). In some embodiments, a heterogeneous mixture may have a longer associated delay time for the treatment chemical, depending on, inter alia, the salts present in the mixture. The primary considerations in determining what degree of encagement is appropriate include, but are not limited to: the treatment chemical and its reactivity in the subterranean formation; the treatment chemical and its reactivity in the particular treatment fluids to which it is exposed; the desired delay period before release of the treatment chemical; and the compositions of the treatment chemical and polymer matrix (e.g., vis-à-vis each other).

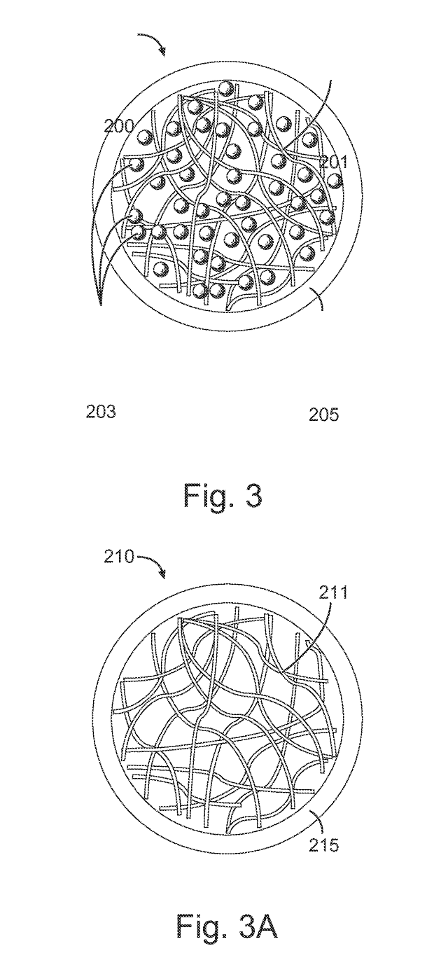

An example of one embodiment of a treatment particulate of the present disclosure is shown in FIG. 3. Referring now to FIG. 3, treatment particulate 200 includes a polymer matrix 201 in which smaller particulates 203 of a treatment chemical are encaged. Treatment particulate 200 also includes a coating 205 disposed around the outermost surface of the polymer matrix 201. While coating 205 is shown as completely encapsulating the polymer matrix 201, the coatings in other embodiments of the present disclosure may only cover some portion of the outer surface of the polymer matrix.

Referring now to FIG. 3A, another embodiment of a treatment particulate 210 of the present disclosure is shown. Like treatment particulate 200 of FIG. 3, the treatment particulate 210 includes a polymer matrix 211 and a coating 215 disposed around the outermost surface of the polymer matrix 211. However, the polymer matrix 211 itself is comprised of one or more solid treatment chemicals that may be released from the polymer matrix 211 when introduced into a subterranean formation. As a person of ordinary skill in the art will recognize polymer matrix 201 of FIG. 3 may also comprise an active polymer matrix in which, in addition to the encaged treatment chemicals 203, itself includes one or more solid treatment chemicals that may be released from the polymer matrix 201 when introduced into a subterranean formation.

Another embodiment of a treatment particulate of the present disclosure is shown in FIG. 4. Referring now to FIG. 4, similar to the embodiment shown in FIG. 3, treatment particulate 300 includes a polymer matrix 301 in which smaller particulates 303 of a treatment chemical are encaged. Treatment particulate 300 also includes a coating 305 disposed around the outermost surface of the polymer matrix 301. In this embodiment, treatment particulate 300 also includes a second coating 307 that is disposed around the outermost surface of the first coating 305. In certain of these embodiments, the first and second coatings may, among other benefits, enhance the durability and/or stability of treatment particulate 300, and/or may be formulated to enhance its performance where the treatment particulate may be subjected to multiple different environments and/or conditions in a subterranean formation. For example, the second coating 307 may prevent the premature release of the treatment chemical 303 in certain types of environments in which the second coating will not degrade or dissolve (e.g., aqueous environments), while the first coating 305 may prevent the premature release of the treatment chemical 303 in certain types of environments in which the first coating 305 will not degrade or dissolve (e.g., oil-based environments). While not shown, embodiments like those shown in FIG. 4 may include an active polymer matrix like that of FIG. 3A that itself comprises treatment chemicals that may be released form the matrix, in which case treatment particulate 300 may or may not include particulates of solid treatment chemicals encaged in polymer matrix 301 as shown.

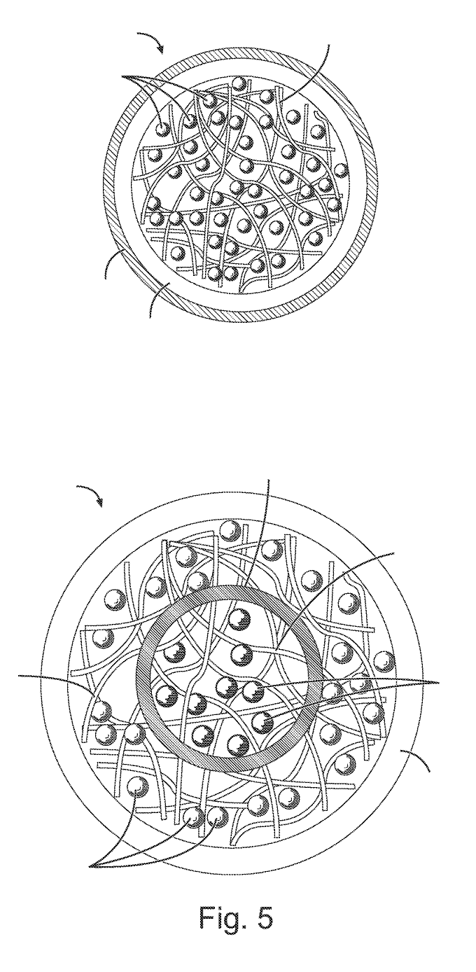

Another embodiment of a treatment particulate of the present disclosure is shown in FIG. 5. Referring now to FIG. 5, similar to the embodiments shown in FIG. 3 and FIG. 4, treatment particulate 400 includes a first polymer matrix 401 in which smaller particulates 403 of a treatment chemical are encaged, and a coating 405 around the outermost surface of polymer matrix 401. In this embodiment, treatment particulate 400 also includes a second polymer matrix 409 and encaged treatment chemical particulates 412 within another coating 407 that is surrounded by the first polymer matrix 401 and its coating 405. In certain embodiments, the second polymer matrix 409, coating 407, and/or treatment chemical particulates 412 may comprise the same materials as polymer matrix 401, coating 405, and treatment chemical particulates 403, respectively. In other embodiments, one or more of those elements may differ from their counterparts (e.g., the treatment chemical in particulates 412 may be a different treatment chemical from that in particulates 403). In certain of these embodiments, the various components of treatment particulate 400 may be formulated, among other purposes, to allow for the selective release of multiple solid treatment chemicals (or different amounts of the same treatment chemical) in a single area of the formation at different points in time. For example, coating 405 may be selected to at least partially dissolve and/or degrade in certain environments or conditions (e.g., aqueous environments) while coating 407 does not dissolve or degrade in that environment or in those conditions. As a result, treatment chemical 403 may be released in that environment or condition while treatment chemical 412 is not. At some later point in time, after coating 405 has at least partially dissolved and/or degraded, treatment particulate 400 may be exposed to an environment or condition in which coating 407 will at least partially dissolve and/or degrade, and thus treatment chemical 412 may be released at that point. While not shown, embodiments like those shown in FIG. 5 may include an active polymer matrix like that of FIG. 3A that itself comprises treatment chemicals that may be released form the matrix, in which case treatment particulate 400 may or may not include particulates of solid treatment chemicals encaged in polymer matrices 401 and/or 409 as shown.

Any method known in the art may be used to create the polymer matrix of the present disclosure. In some embodiments, a suitable monomer is mixed with a suitable treatment chemical and then the monomer is allowed to polymerize so as to encage the treatment chemical (referred to herein as the “monomer embodiments”). In such monomer embodiments, any known suitable polymerization method (including, but not limited to, free radical polymerization, condensation polymerization, vinyl polymerization, emulsion polymerization, etc.) may be used. In other embodiments of the present disclosure, a polymer may be mixed with a treatment chemical and then crosslinked around the treatment chemical. In embodiments of the present disclosure wherein a monomer is made to polymerize to substantially surround a treatment chemical, a mixture comprising the monomer and the treatment chemical are combined along with a polymerization activator such that the monomer polymerizes to eventually form a polymer matrix around the treatment chemical. In some embodiments, a crosslinking agent may also be added to the mixture to cause the formed polymer to have crosslinks. The choice of monomer, polymerization activator, and crosslinking agent (when used) should be made in such a way that the chosen compounds will not negatively interact with the chosen treatment chemical. In that way, the treatment chemical may be at least partially physically trapped within the polymer matrix. In some embodiments of the present disclosure, the treatment chemical may be covalently or otherwise weakly reversibly bonded to the treatment chemical.

In the monomer embodiments, a variety of monomers may be suitable. Examples include, but are not limited to, acrylamide; styrene; butadiene; methacrylate; N-isopropyl acrylamide; N,N-dimethyl acrylamide; methacrylamide; and, methylacrylate. Acrylamide is a preferred monomer. Other monomers known in the art that are capable of being polymerized also may be suitable for use in the present disclosure. Examples include anionic monomers (such as sodium acrylate) or cationic polymers (such as trimethyl allyl ammonium chloride and dimethyl diallyl ammonium chloride). One should be mindful that ionic attraction between the monomer/polymer and the treatment chemical may affect the diffusion rate of the treatment chemical. Selection of an appropriate monomer may be based, at least in part, on the environment in which the encaged treatment chemical is to be used. For example, it may be important to consider whether the treatment chemical will be released into an oil-based or water-based environment. Moreover, the choice of a monomer may depend on the treatment chemical. For example, a hydrophobic monomer may be used with a water-soluble treatment chemical, while a hydrophilic monomer may be preferred for an oil-soluble treatment chemical. In other cases, hydrophobic monomers may be combined with hydrophilic monomers to tune the release of the encaged treatment chemical through the resultant polymer matrix. For example, creating polymer gels whose surface is more hydrophobic, thereby slowing the hydration with water, may slow the diffusion rate. With the benefit of this disclosure, it should be within the ability of one skilled in the art to select an appropriate monomer. In some embodiments of the present disclosure the monomer is present in the mixture used to create the encaged treatment chemical in an amount ranging from about 10% to about 60% of the mixture. In some embodiments of the present disclosure the monomer is present in the mixture in an amount ranging from about 15% to about 35% of the mixture.

In some embodiments, a variety of polymerization activators may be used in the monomer embodiments of the methods of the present disclosure. In one embodiment, wherein the monomer is to be polymerized using free-radical polymerization, the polymerization activator may comprise a free-radical source. Generally, suitable free-radical sources are thermal free-radical initiators. Some suitable free-radical sources include, but are not limited to, sodium persulfate, sodium, potassium or organic peroxides, and sodium or potassium perborate bis azo compounds (“AIBN”). In other embodiments, a suitable polymerization activator may be a physical catalyst such as heat, time, or mechanical shear. In embodiments wherein the polymerization activator is a free radical source, a chain-transfer agent may be used to make the free-radical source more active. Generally, the chain-transfer agent forms an N-oxide that is capable of reacting with a free-radical source to form a stabilized free radical, thus lengthening the lifetime of the free radical. Any water soluble amine may be used as a suitable chain-transfer agent, including triethanolamine, spermidine, pyridine, and N-methylmorpholine.

In the monomer embodiments, optionally, a suitable crosslinking agent may be included so that crosslinks between polymeric molecules are incorporated within the three-dimensional structure of the polymer matrix. Suitable crosslinking agents typically comprise at least one ion that is capable of crosslinking at least two polymer molecules. Examples of suitable crosslinking agents include, but are not limited to, boric acid, disodium octaborate tetrahydrate, sodium diborate, pentaborates, ulexite and colemanite, compounds that can supply zirconium IV ions (such as, for example, zirconium lactate, zirconium lactate triethanolamine, zirconium carbonate, zirconium acetylacetonate, zirconium malate, zirconium citrate, and zirconium diisopropylamine lactate); compounds that can supply titanium IV ions (such as, for example, titanium lactate, titanium malate, titanium citrate, titanium ammonium lactate, titanium triethanolamine, and titanium acetylacetonate); aluminum compounds (such as, for example, aluminum lactate or aluminum citrate); antimony compounds; chromium compounds; iron compounds; copper compounds; zinc compounds; or a combination thereof. An example of a suitable commercially available zirconium-based crosslinking agent is “CL-24” available from Halliburton Energy Services, Inc., Duncan, Okla. An example of a suitable commercially available titanium-based crosslinking agent is “CL-39” available from Halliburton Energy Services, Inc., Duncan Okla. When used, the crosslinking agent is generally included with the treatment chemical and monomer in an amount ranging from about 10% to about 40% of the total mixture. In some embodiments, the crosslinking agent is included with the treatment chemical and monomer in an amount ranging from about 15% to about 35% of the total mixture.

In other embodiments, rather than starting with a monomer to form an encaged treatment chemical, a polymer may be used (referred to as the “polymer embodiments”). In these embodiments, suitable polymer molecules may be mixed with an (optional) crosslinking agent and a treatment chemical to form an encaged treatment chemical. The treatment chemical may be embedded within pockets of the three-dimensional polymer matrix formed by the interactions and polymerizations of the polymer molecules and the crosslinking agent. In the polymer embodiments, a variety of polymers may be suitable. Suitable polymers typically comprise polymers, synthetic polymers, or a combination thereof. Examples include, but not limited to, hydratable polymers that contain one or more functional groups such as hydroxyl, cis-hydroxyl, carboxylic acids, and derivatives of carboxylic acids, sulfate, sulfonate, phosphate, phosphonate, amino, or amide. In certain exemplary embodiments, the polymers may comprise polysaccharides, and derivatives thereof that contain one or more of the following monosaccharide units: galactose, mannose, glucoside, glucose, xylose, arabinose, fructose, glucuronic acid, and pyranosyl sulfate. Examples of suitable polymers include, but are not limited to, guar gum and derivatives thereof, such as hydroxypropyl guar and carboxymethylhydroxypropyl guar, and cellulose derivatives, such as hydroxyethyl cellulose. Additionally, synthetic polymers and copolymers that contain the above-mentioned functional groups may be used. Examples of such synthetic polymers include, but are not limited to, polyacrylate, polymethacrylate, polyacrylamide, polyvinyl alcohol, and polyvinylpyrrolidone. In other exemplary embodiments, the polymer may be somewhat depolymerized. The term “depolymerized,” as used herein, generally refers to a decrease in the molecular weight of the polymer.

In the polymer embodiments, optionally a crosslinking agent may be used. A variety of crosslinking agents may be suitable. Examples of suitable crosslinking agents include, but are not limited to, boric acid, disodium octaborate tetrahydrate, sodium diborate, pentaborates, ulexite and colemanite, compounds that can supply zirconium IV ions (such as, for example, zirconium lactate, zirconium lactate triethanolamine, zirconium carbonate, zirconium acetylacetonate, zirconium malate, zirconium citrate, and zirconium diisopropylamine lactate); compounds that can supply titanium IV ions (such as, for example, titanium lactate, titanium malate, titanium citrate, titanium ammonium lactate, titanium triethanolamine, and titanium acetylacetonate); aluminum compounds (such as, for example, aluminum lactate or aluminum citrate); antimony compounds; chromium compounds; iron compounds; copper compounds; zinc compounds; or a combination thereof. An example of a suitable commercially available zirconium-based crosslinking agent is “CL-24” available from Halliburton Energy Services, Inc., Duncan, Okla. An example of a suitable commercially available titanium-based crosslinking agent is “CL-39” available from Halliburton Energy Services, Inc., Duncan Okla. When used, the crosslinking agent is generally included with the treatment chemical and polymer in an amount ranging from about 10% to about 40% of the total mixture. In some embodiments, the crosslinking agent is included with the treatment chemical and polymer in an amount ranging from about 15% to about 35% of the total mixture.

Once the polymer matrix comprising and/or encaging the treatment chemical has been formed by any suitable method, it may be used in that form or, alternatively, it may be dehydrated and ground to particulates of a suitable size for use down hole. In certain embodiments, the dehydration process may involve vacuum drying. In certain embodiments, the treatment particulates may be ground to a size and/or shape that is similar to other particulates (e.g., proppant particulates) that are to be used in the same treatment fluid and/or subterraneant formation. The grind size may provide a further variable through which to control the diffusion of the treatment chemicals out of the polymer matrix. In certain embodiments, the treatment particulates (either prior to or after coating) may range in size from about 4 to about 100 mesh U.S. Sieve Series. In certain embodiments, the treatment particulates (either prior to or after coating) may range in size from about 20 to about 40 mesh U.S. Sieve Series. In certain embodiments, the treatment particulates (either prior to or after coating) may range in size from about 30 to about 80 mesh U.S. Sieve Series. In other embodiments, the treatment particulate may be added without dehydration (therefore no grinding is necessary). In such embodiments, the treatment particulate may be added to the treatment fluid as an emulsion or slurry. In certain embodiments, the treatment particulates are generally provided as a plurality of discrete particulates that each comprise the polymer matrix material and are individually coated around their outer surfaces, as opposed to a conglomerate mass of polymer matrix material.

Any treatment chemical that is useful down hole and that does not adversely react with the polymer matrix may be used as a treatment chemical in the present disclosure. Examples of treatment chemicals that may be suitable for certain embodiments of the present disclosure include, but are not limited to, chelating agents (e.g., EDTA, citric acid, polyaspartic acid), scale inhibitors, gel breakers, dispersants, paraffin inhibitors, asphaltene inhibitors, wax inhibitors, hydrate inhibitors, corrosion inhibitors, de-emulsifiers, foaming agents, tracers, defoamers, delinkers, scale inhibitors, crosslinkers, surfactants, salts, acids, catalysts, clay control agents, biocides, friction reducers, flocculants, H₂S scavengers, CO₂ scavengers, oxygen scavengers, lubricants, viscosifiers, relative permeability modifiers, surfactants, wetting agents, filter cake removal agents, antifreeze agents and any derivatives and/or combinations thereof.

The coatings in the treatment particulates of the present disclosure may comprise any materials known in the art suitable for forming coatings on surfaces, including but not limited to polymeric materials. These coatings may be hydrophobic or hydrophilic in nature, depending on the intended use of the treatment particulate. Examples of materials that may be used to form coatings in the treatment particulates of the present disclosure include, but are not limited to degradable polymers, nylon, waxes, drying oils, polyurethanes, polyacrylics, silicate materials, glass materials, inorganic durable materials, phenolics, biopolymers (e.g., cellulose), polysaccharides, hydrocolloids, gums, and any derivatives and/or combinations thereof. The coating may be of any thickness appropriate for a particular application of the present disclosure, which a person of skill in the art with the benefit of this disclosure will recognize. The coating material may be applied to the outer surface of a polymer matrix to form a treatment particulate of the present disclosure using any means or technique known in the art, including but not limited to fluidized bed processes, pan coating processes, Wurster processes, top spray processes, spinning disk atomization processes, chemical encapsulation processes, and the like.

For example, in spinning disk atomization methods, the polymer matrix material may be dispersed in a coating solution or melt and fed onto the center of a rotating disk atomizer. The materials then are atomized at the periphery of the disk, and the atomized droplets are solidified by removal of the coating solvent or congealing of the melt, thereby entrapping the chemicals within the coating matrix. In spray coating methods, the raw polymer matrix material or encapsulated polymer matrix microspheres will be suspended within a chamber and a coating sprayed onto the surface. In certain embodiments, by controlling the spray time, various coating thickness can be applied, among other reasons, to tailor the performance of the encapsulated product. Examples of chemical encapsulation techniques that may be suitable for coating treatment particulates of the present disclosure may include, but are not limited to, in situ solution polymerization techniques, interfacial polymerization techniques, emulsion polymerization techniques, simple and complex coacervation, and the like.

The treatment fluids used in the methods, systems, and compositions of the present disclosure may comprise any base fluid known in the art, including aqueous base fluids, non-aqueous base fluids, and any combinations thereof. Aqueous fluids that may be suitable for use in the methods and systems of the present disclosure may comprise water from any source. Such aqueous fluids may comprise fresh water, salt water (e.g., water containing one or more salts dissolved therein), brine (e.g., saturated salt water), seawater, or any combination thereof. In most embodiments of the present disclosure, the aqueous fluids comprise one or more ionic species, such as those formed by salts dissolved in water. For example, seawater and/or produced water may comprise a variety of divalent cationic species dissolved therein. In certain embodiments, the density of the aqueous fluid can be adjusted, among other purposes, to provide additional particulate transport and suspension in the compositions of the present disclosure. In certain embodiments, the pH of the aqueous fluid may be adjusted (e.g., by a buffer or other pH adjusting agent) to a specific level, which may depend on, among other factors, the types of viscosifying agents, acids, and other additives included in the fluid. One of ordinary skill in the art, with the benefit of this disclosure, will recognize when such density and/or pH adjustments are appropriate. Examples of non-aqueous fluids that may be suitable for use in the methods and systems of the present disclosure include, but are not limited to, oils, hydrocarbons, organic liquids, and the like. In certain embodiments, the fracturing fluids may comprise a mixture of one or more fluids and/or gases, including but not limited to emulsions, foams, and the like.

In certain embodiments, the treatment fluids used in the methods, systems, and compositions of the present disclosure optionally may comprise any number of additional additives. Examples of such additional additives include, but are not limited to, salts, surfactants, acids, proppant particulates, diverting agents, fluid loss control additives, gas, nitrogen, carbon dioxide, surface modifying agents, tackifying agents, foamers, corrosion inhibitors, scale inhibitors, catalysts, clay control agents, biocides, friction reducers, antifoam agents, bridging agents, flocculants, additional H₂S scavengers, CO₂ scavengers, oxygen scavengers, lubricants, additional viscosifiers, breakers, weighting agents, relative permeability modifiers, resins, wetting agents, coating enhancement agents, filter cake removal agents, antifreeze agents (e.g., ethylene glycol), and the like. In certain embodiments, one or more of these additional additives (e.g., a crosslinking agent) may be added to the treatment fluid and/or activated after the viscosifying agent has been at least partially hydrated in the fluid. A person skilled in the art, with the benefit of this disclosure, will recognize the types of additives that may be included in the fluids of the present disclosure for a particular application.

The present disclosure in some embodiments provides methods for using the treatment fluids to carry out a variety of subterranean treatments, including but not limited to, hydraulic fracturing treatments, acidizing treatments, and drilling operations. In some embodiments, the treatment fluids of the present disclosure may be used in treating a portion of a subterranean formation, for example, in acidizing treatments such as matrix acidizing or fracture acidizing. In certain embodiments, a treatment fluid may be introduced into a subterranean formation. In some embodiments, the treatment fluid may be introduced into a well bore that penetrates a subterranean formation. In some embodiments, the treatment fluid may be introduced at a pressure sufficient to create or enhance one or more fractures within the subterranean formation (e.g., hydraulic fracturing).

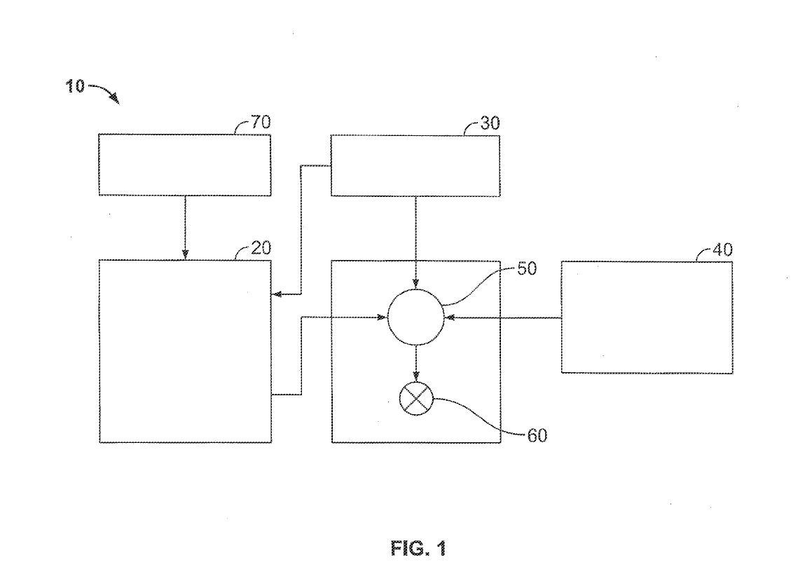

Certain embodiments of the methods and compositions disclosed herein may directly or indirectly affect one or more components or pieces of equipment associated with the preparation, delivery, recapture, recycling, reuse, and/or disposal of the disclosed compositions. For example, and with reference to FIG. 1, the disclosed methods and compositions may directly or indirectly affect one or more components or pieces of equipment associated with an exemplary fracturing system 10, according to one or more embodiments. In certain instances, the system 10 includes a fracturing fluid producing apparatus 20, a fluid source 30, a proppant source 40, and a pump and blender system 50 and resides at the surface at a well site where a well 60 is located. In certain instances, the fracturing fluid producing apparatus 20 combines a gel pre-cursor with fluid (e.g., liquid or substantially liquid) from fluid source 30, to produce a hydrated fracturing fluid that is used to fracture the formation. The hydrated fracturing fluid can be a fluid for ready use in a fracture stimulation treatment of the well 60 or a concentrate to which additional fluid is added prior to use in a fracture stimulation of the well 60. In other instances, the fracturing fluid producing apparatus 20 can be omitted and the fracturing fluid sourced directly from the fluid source 30. In certain instances, the fracturing fluid may comprise water, a hydrocarbon fluid, a polymer gel, foam, air, wet gases and/or other fluids.

The proppant source 40 can include a proppant for combination with the fracturing fluid. In certain embodiments, one or more treatment particulates of the present disclosure may be provided in the proppant source 40 and thereby combined with the fracturing fluid with the proppant. The system may also include additive source 70 that provides one or more additives (e.g., gelling agents, weighting agents, and/or other optional additives) to alter the properties of the fracturing fluid. For example, the other additives 70 can be included to reduce pumping friction, to reduce or eliminate the fluid's reaction to the geological formation in which the well is formed, to operate as surfactants, and/or to serve other functions. In certain embodiments, the other additives 70 may include one or more treatment particulates of the present disclosure.

The pump and blender system 50 receives the fracturing fluid and combines it with other components, including proppant from the proppant source 40 and/or additional fluid from the additives 70. The resulting mixture may be pumped down the well 60 under a pressure sufficient to create or enhance one or more fractures in a subterranean zone, for example, to stimulate production of fluids from the zone. Notably, in certain instances, the fracturing fluid producing apparatus 20, fluid source 30, and/or proppant source 40 may be equipped with one or more metering devices (not shown) to control the flow of fluids, proppants, and/or other compositions to the pumping and blender system 50. Such metering devices may permit the pumping and blender system 50 can source from one, some or all of the different sources at a given time, and may facilitate the preparation of fracturing fluids in accordance with the present disclosure using continuous mixing or “on-the-fly” methods. Thus, for example, the pumping and blender system 50 can provide just fracturing fluid into the well at some times, just proppants at other times, and combinations of those components at yet other times.

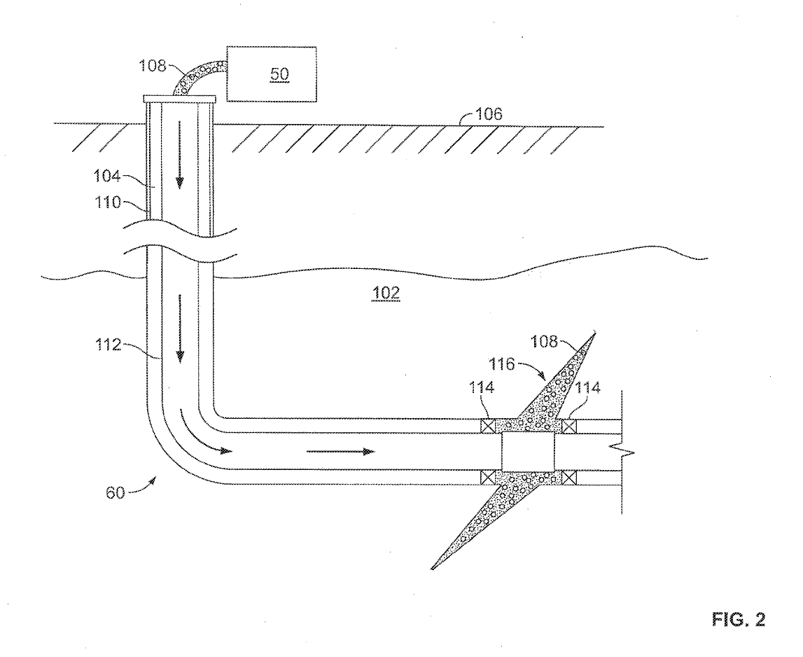

FIG. 2 shows the well 60 during a fracturing operation in a portion of a subterranean formation of interest 102 surrounding a well bore 104. The well bore 104 extends from the surface 106, and the fracturing fluid 108 is applied to a portion of the subterranean formation 102 surrounding the horizontal portion of the well bore. Although shown as vertical deviating to horizontal, the well bore 104 may include horizontal, vertical, slant, curved, and other types of well bore geometries and orientations, and the fracturing treatment may be applied to a subterranean zone surrounding any portion of the well bore. The well bore 104 can include a casing 110 that is cemented or otherwise secured to the well bore wall. The well bore 104 can be uncased or include uncased sections. Perforations can be formed in the casing 110 to allow fracturing fluids and/or other materials to flow into the subterranean formation 102. In cased wells, perforations can be formed using shape charges, a perforating gun, hydro-jetting and/or other tools.

The well is shown with a work string 112 depending from the surface 106 into the well bore 104. The pump and blender system 50 is coupled a work string 112 to pump the fracturing fluid 108 into the well bore 104. The working string 112 may include coiled tubing, jointed pipe, and/or other structures that allow fluid to flow into the well bore 104. The working string 112 can include flow control devices, bypass valves, ports, and or other tools or well devices that control a flow of fluid from the interior of the working string 112 into the subterranean zone 102. For example, the working string 112 may include ports adjacent the well bore wall to communicate the fracturing fluid 108 directly into the subterranean formation 102, and/or the working string 112 may include ports that are spaced apart from the well bore wall to communicate the fracturing fluid 108 into an annulus in the well bore between the working string 112 and the well bore wall.

The working string 112 and/or the well bore 104 may include one or more sets of packers 114 that seal the annulus between the working string 112 and well bore 104 to define an interval of the well bore 104 into which the fracturing fluid 108 will be pumped. FIG. 2 shows two packers 114, one defining an uphole boundary of the interval and one defining the downhole end of the interval. When the fracturing fluid 108 is introduced into well bore 104 (e.g., in FIG. 2, the area of the well bore 104 between packers 114) at a sufficient hydraulic pressure, one or more fractures 116 may be created in the subterranean zone 102. The proppant particulates (and/or treatment particulates of the present disclosure) in the fracturing fluid 108 may enter the fractures 116 where they may remain after the fracturing fluid flows out of the well bore. These proppant particulates may “prop” fractures 116 such that fluids may flow more freely through the fractures 116.

While not specifically illustrated herein, the disclosed methods and compositions may also directly or indirectly affect any transport or delivery equipment used to convey the compositions to the fracturing system 10 such as, for example, any transport vessels, conduits, pipelines, trucks, tubulars, and/or pipes used to fluidically move the compositions from one location to another, any pumps, compressors, or motors used to drive the compositions into motion, any valves or related joints used to regulate the pressure or flow rate of the compositions, and any sensors (i.e., pressure and temperature), gauges, and/or combinations thereof, and the like.

An embodiment of the present disclosure is a method comprising: providing a plurality of treatment particulates, at least one of which comprising a polymer matrix, at least one treatment chemical encaged within the polymer matrix, and a coating disposed around an outer surface of the polymer matrix; and introducing the treatment particulates into a well bore penetrating at least a portion of a subterranean formation.

Another embodiment of the present disclosure is a method comprising: providing a plurality of treatment particulates, at least one of which comprising an active polymer matrix that comprises at least one treatment chemical, and a coating disposed around an outer surface of the polymer matrix; and introducing the treatment particulates into a well bore penetrating at least a portion of a subterranean formation.

Another embodiment of the present disclosure is a treatment particulate composition comprising: a first polymer matrix; a first treatment chemical encaged within the first polymer matrix; a first coating disposed around an outer surface of the first polymer matrix; a second polymer matrix disposed around an outer surface of the first coating; a second treatment chemical encaged within the second polymer matrix; and a second coating disposed around an outer surface of the second polymer matrix.

Another embodiment of the present disclosure is a treatment particulate composition comprising: a first active polymer matrix comprising a first treatment chemical; a first coating disposed around an outer surface of the first polymer matrix; a second active polymer matrix comprising a second treatment chemical, the second polymer matrix being disposed around an outer surface of the first coating; and a second coating disposed around an outer surface of the second polymer matrix.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. While numerous changes may be made by those skilled in the art, such changes are encompassed within the spirit of the subject matter defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. In particular, every range of values (e.g., “from about a to about b,” or, equivalently, “from approximately a to b,” or, equivalently, “from approximately a-b”) disclosed herein is to be understood as referring to the power set (the set of all subsets) of the respective range of values. The terms in the claims have their plain, ordinary meaning unless otherwise explicitly and clearly defined by the patentee.

What is claimed is:

1. A method comprising:
providing a plurality of treatment particulates, at least one of which comprising a polymer matrix, at least one treatment chemical encaged within the polymer matrix, and a coating disposed around an outer surface of the polymer matrix; and
introducing the treatment particulates into a well bore penetrating at least a portion of a subterranean formation.

2. The method of claim 1 further comprising:
allowing the coating to delay the release of the treatment chemical in the formation; and
allowing the polymer matrix to control the release of the treatment chemical in the formation.

3. The method of claim 1 wherein the treatment chemical comprises at least one chemical additive selected from the group consisting of: a paraffin inhibitor, an asphaltene inhibitor, a hydrate inhibitor, a scale inhibitor, a biocide, a surfactant, a corrosion inhibitor, an H₂S scavenger, and any combination thereof.

4. The method of claim 1 wherein the treatment chemical is in solid form.

5. The method of claim 1 further comprising:
mixing the treatment particulates with a fracturing fluid; and
introducing the fracturing fluid into a well bore penetrating at least a portion of a subterranean formation at or above a pressure sufficient to create or enhance at least one fracture in at least a portion of the subterranean formation.

6. The method of claim 5 further comprising depositing the treatment particulates in at least a portion of a fracture in the subterranean formation.

7. The method of claim 5 wherein the fracturing fluid is introduced into a subterranean formation using one or more pumps.

8. The method of claim 1 wherein the particulates each have an average particle size of from about 4 mesh to about 100 mesh U.S. Sieve Series.

9. A method comprising:
providing a plurality of treatment particulates, at least one of which comprising an active polymer matrix that comprises at least one treatment chemical, and a coating disposed around an outer surface of the polymer matrix; and
introducing the treatment particulates into a well bore penetrating at least a portion of a subterranean formation.

10. The method of claim 9 further comprising:
allowing the coating to delay the release of the treatment chemical in the formation; and
allowing the polymer matrix to control the release of the treatment chemical in the formation.

11. The method of claim 9 wherein the treatment particulates further comprise at least one treatment chemical engaged within the polymer matrix.

12. The method of claim 11 wherein the encaged treatment chemical is in solid form.

13. The method of claim 9 further comprising:
mixing the treatment particulates with a fracturing fluid; and
introducing the fracturing fluid into a well bore penetrating at least a portion of a subterranean formation at or above a pressure sufficient to create or enhance at least one fracture in at least a portion of the subterranean formation.

14. The method of claim 13 further comprising depositing the treatment particulates in at least a portion of a fracture in the subterranean formation.

15. The method of claim 9 wherein the particulates each have an average particle size of from about 4 mesh to about 100 mesh U.S. Sieve Series.

16. A treatment particulate composition comprising:
a first polymer matrix;
a first treatment chemical encaged within the first polymer matrix;
a first coating disposed around an outer surface of the first polymer matrix;
a second polymer matrix disposed around an outer surface of the first coating;
a second treatment chemical encaged within the second polymer matrix; and
a second coating disposed around an outer surface of the second polymer matrix.

17. The treatment particulate composition of claim 16 wherein the first and second encaged treatment chemicals are in solid form.

18. The treatment particulate composition of claim 16 wherein the particulates each have an average particle size of from about 4 mesh to about 100 mesh U.S. Sieve Series.

19. The treatment particulate composition of claim 16 wherein the particulates each have an average particle size of from about 30 mesh to about 80 mesh U.S. Sieve Series.

20. The treatment particulate composition of claim 16 wherein the particulates each have an average particle size of from about 20 mesh to about 40 mesh U.S. Sieve Series.

21. (canceled)

22. (canceled)

23. (canceled)
